(19) United States
(12) Patent Application Publication
(10) Pub. No.: US 2004/0060931 A1
(43) Pub. Date: Apr. 1, 2004

(54) Combination microwave, hot air and hot plate cooker

(76) Inventor: Jing-Yau Chung, Houston, TX (US)

Correspondence Address: MARK A OATHOUT, 3730 KIRBY DRIVE, SUITE 830, HOUSTON, TX, 77098

(21) Appl. No.: 10/672,208

(22) Filed: Sep. 26, 2003

Related U.S. Application Data
(60) Provisional application No. 60/413,956, filed on Sep. 26, 2002.

(51) Int. Cl. H05B 6/64

(52) U.S. Cl. 219/680

(57) ABSTRACT

A heating system has three modes of heating. The system includes a hot plate, a heating chamber or oven and an air circulation system for heating a food product. The three modes of heating may be integrated at the heating chamber.

### CROSS-REFERENCE TO RELATED APPLICATIONS

This application claims the benefit of U.S. provisional application No. 60/413,956 filed Sep. 26, 2002.

### STATEMENTS REGARDING FEDERALLY SPONSORED RESEARCH OR DEVELOPMENT

Not applicable.

### REFERENCE TO A MICROFICHE APPENDIX

Not applicable.

### BRIEF SUMMARY OF THE INVENTION

A heating system has three modes of heating. The system includes a hot plate, a heating chamber or oven and an air circulation system for heating a food product. The three modes of heating may be integrated at the heating chamber.

The present invention recognizes, addresses and meets several objectives in its various possible embodiments and equivalents thereof. To one of skill in this art who has the benefit of this invention's realizations, teachings, disclosures, and suggestions, other purposes and advantages will be appreciated from the following description and the accompanying drawings. The detail in the description is not intended to thwart this patent's object to claim this invention no matter how others may later disguise it by variations in form or additions of further improvements. These descriptions illustrate certain preferred embodiments and are not to be used to improperly limit the scope of the invention which may have other equally effective or legally equivalent embodiments.

### BRIEF DESCRIPTION OF THE DRAWINGS

FIG. 1 is a top view of the invention.

FIG. 2 is a sectional view taken along line 2-2 of FIG. 1.

FIG. 3 is a top view of a second embodiment of the invention.

FIG. 4 is a top view of a third embodiment of the invention.

### DETAILED DESCRIPTION OF THE INVENTION

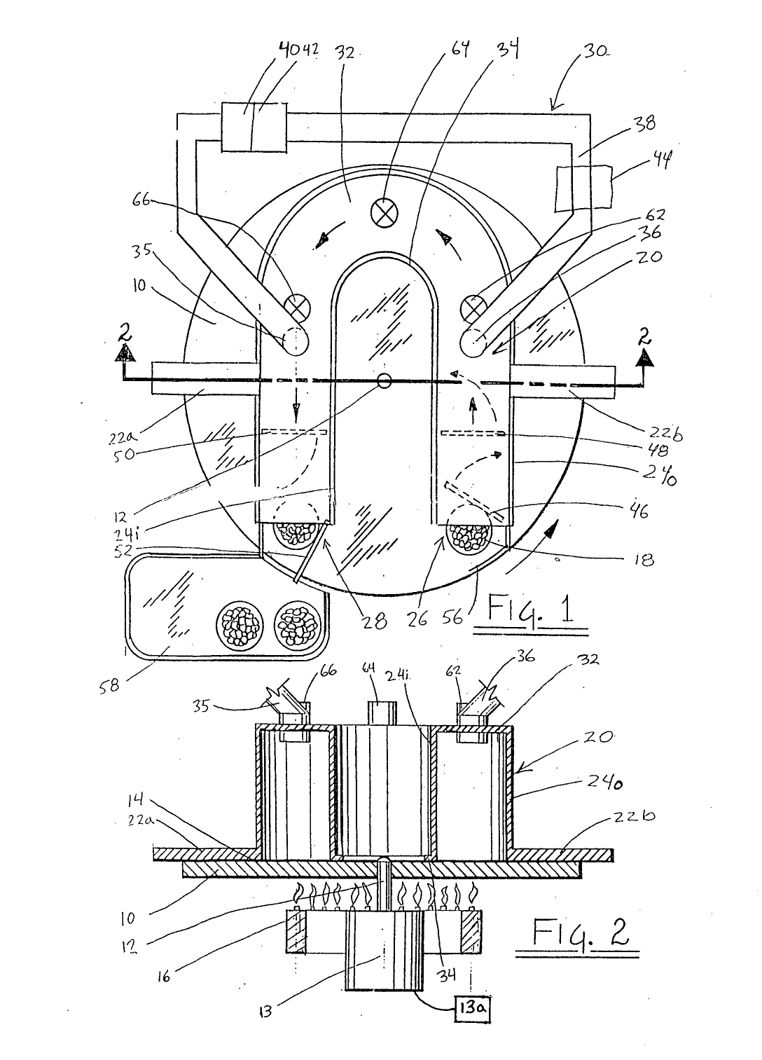

The present invention relates generally to a system having three modes of heating. This system includes a hot plate 10, a heating chamber or oven 20 and an air circulation system 30 for heating a food product 18. Referring to FIGS. 1-2, the heating chamber 20 integrates at least three modes of heating (microwave, hot plate and heated air) and is mounted on a hot plate 10.

The hot plate 10 is metallic and rotates about an axis 12 which is driven by a motor 13 (it is not required that the motor 13 be in the center of the hot plate 10). The top surface 14 of the hot plate 10 is coated with a material, such as TEFLON, with known advantageous qualities for heating a food product 18. The hot plate 10 is heated by a gas heater 16 or some other suitable heating mode such as electricity. The hot plate 10 may, for example, be round.

The heating chamber 20 is generally bounded or defined by inner wall 24i and outer wall 24o which adjoin top 32 and which are mounted on hot plate 10. The bottom of the inner wall 24i and the bottom of the outer wall 24o may include a flange 24. The heating chamber 20 is generally tubular and arcuate when viewed from the top (U-shape shown).

As previously mentioned, the heating chamber 20 includes a microwave mode of heating in addition to the hot plate mode described above. Magnetrons 62, 64 and 66 are mounted on the top 32 of the heating chamber 20 but could be mounted in other locations such as on the inner wall 24i or on the outer wall 24o. The magnetrons 62, 64 and 66 create a microwave field within the heating chamber 20. The invention is operable with one or more magnetron. The chamber 20 also includes double doors 46 and 48 and double doors 50 and 52 to prevent the escape of microwaves and hot air from the chamber 20. The doors 46, 48, 50 and 52 may be opened by a mechanical means such as a spring (not shown), an automatic means such as an electric eye (not shown), etc. When one of the double doors is closed, e.g. door 48, the gaps or tolerance between the door 48 and the inner wall 24i, the outer wall 24o, the top 32 and the hot plate 10 must be tight or small enough to prevent the escape of microwaves and hot air. The bottom of the inner wall 24i and the bottom of the outer wall 24o touches or is close enough to the hot plate 10 to prevent the escape of microwaves and hot air.

As previously mentioned, the heating chamber 20 also includes a hot air mode of heating in addition to the hot plate and the microwave mode of heating. The hot air system 30 generally moves hot air in and out of the heating chamber 20. It includes a hot air line 38 having an inlet end 35 and an outlet end 36 connected to the top 32 of the heating chamber 20 or to some other suitable location. The hot air system 30 also includes a blower 40, a heater 42 and a smoke and grease filter 44 connected to the hot air line 38. The heater 42 may be heated by gas, electricity, etc. The inlet end 35 and the outlet end 36 should be spaced apart whereby the hot air flows through the heating chamber 20. This may also be accomplished by including a nozzle (not shown) at the inlet end 35 of air line 38 to direct the movement of hot air toward the outlet end 36.

Additional modes of heating could be incorporated into the invention. For example, a hot oil heating system (not shown) could be added to spray the food product 18 with hot oil or to submerge the food product 18 in hot oil as it moves through the heating chamber 20.

The food product 18 is moved through the heating chamber 20 and is moved relative to the hot plate 10, both to distribute the food product 18 through varying regions of microwave intensity and to prevent the food product 18 from sticking to the hot plate 10. To accomplish this, the hot plate 10 is rotated counter-clockwise in FIG. 1 by the axis 12 and motor 13. After the food product 18 is placed on the hot plate 10 proximate the entrance 26, the frictional force between the food product 18 and the hot plate 10 causes the food product 18 to move with the hot plate 10. Next, the food product 18 moves through the entrance 26, and through the double doors 46 and 48 in sequence. If the food product 18 strikes the outer wall 24o or the inner wall 24i, the frictional force between the food product 18 and the hot plate 10 and the reactive force of the respective wall, 24o or 24i, causes the food product 18 to rotate and move relative to the hot plate 10 and through the heating chamber 20. Eventually, the food product 18 moves out through double doors 50 and 52. The food product 18 will also be guided through a one hundred and eighty degree turn in a C-shaped heating chamber 20.

Struts 22a and 22b are attached at one end to the heating chamber 20 to keep the inner wall 24i, outer wall 24o and top 32 stationary relative to the hot plate 10. The other ends of the struts 22a and 22b may be attached to a stand (not shown) or some other suitable device.

The heating chamber 20 is constructed such that it has a sufficient path length for proper heating of the food product 18; to be space-saving, such that the invention does not take up too much space in the food preparation area; and such that the configuration of the heating chamber 20 (U-shape shown) does not impede and may actually aid in the movement and uniform heating of the food product 18.

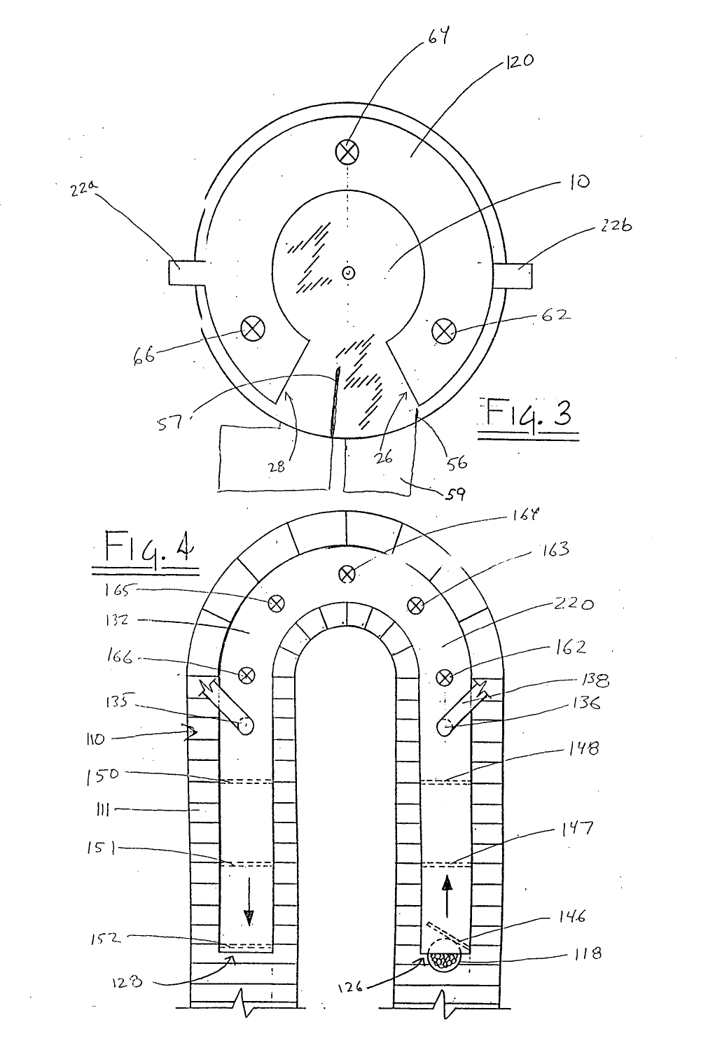

A guide bar 56 may be attached to the outer wall 24o to assist and guide the food product 18 into the heating chamber 20. Tray 58 (FIG. 1) or tray 59 (FIG. 3) may be mounted close to the entry way 26 or exit way 28, respectively. Tray 58 catches the heated food product 18 as it moves out of the heating chamber 20. Tray 59 may be mounted near the entry way 26 and assists in storing and loading the food product 18 to be heated into the heating chamber 20.

Referring to FIG. 3, another embodiment of the invention similar to FIGS. 1-2 is shown. In this embodiment, the heating chamber 120 has a C-shaped configuration as opposed to the U-shape shown in FIG. 1. Also shown is an additional guide bar 57 and a loading tray 59 which is mounted proximate the hot plate 10.

Referring to FIG. 4, another embodiment of the invention is shown. In this embodiment the heating chamber 220 includes magnetrons 162, 163, 164, 165 and 166 mounted on top 132 of the heating chamber 220 for the microwave mode of heating. The hot air line 138 includes inlet end 135 and outlet end 136 for the hot air mode of heating and a heated conveyor 110 which is made from numerous interconnected, intercollapsable metal plates 111. The food product 118 passes through, in sequence, the triple doors 146, 147 and 148, and is transported through the heating chamber 220 by the conveyor 110. The triple doors 146, 147 and 148 dispel the escape of microwaves and hot air from the heating chamber 220. Eventually, the food product 18 will pass through the triple doors 150, 151 and 152 and out of the heating chamber 220.

In general, the microwave emissions diminish according to the distance the microwave travels. More particularly, the intensity of a microwave within a heating chamber will vary according to the square of the distance traveled by the microwave. Therefore, to prevent the escape of microwaves, it may be advantageous, as more particularly shown in FIG. 4, to sufficiently space the entry way 126 from the first magnetron 162 and the exit way 128 from the last magnetron 166. Therefore, impedance may be used to contain or dissipate the microwave field in a heating chamber.

Some examples of types of food products 18 which may be heated or cooked by the present invention include pizza, hamburger meat and cookies. Such food product 18 may be cooked by the present invention in less than one minute. Referring to FIG. 1, the inner wall 24i could be deleted and replaced, for example, by a wall (not shown) running between the entry way 26 and the exit way 28.

The transport means (hot plate 10, conveyor 110) of the present invention could be controlled to adjust the speed or to stop and start again, as needed, for proper heating of the food product. As such, in one optional mode of operation, the hot plate 10 is stationary via a stop-and-start mechanism 13a connected to the motor 13.

In conclusion, therefore, it is seen that the present invention and the embodiments disclosed herein are well adapted to carry out the objectives and obtain the ends set forth. Certain changes can be made in the subject matter without departing from the spirit and the scope of this invention. It is realized that changes are possible within the scope of this invention and it is further intended that each element or step recited is to be understood as referring to all equivalent elements or steps. The description is intended to cover the invention as broadly as legally possible in whatever form it may be utilized.

What is claimed is:

1. An apparatus for heating a food product, comprising:
a hot plate;
a heating chamber including a microwave mode of heating wherein the heating chamber is mounted over the hot plate; and
a motor connected to the hot plate for moving the hot plate.

2. The apparatus according to claim 1, further including an air circulation system connected to the heating chamber.

3. The apparatus according to claim 2, wherein the air circulation system includes a heater.

4. The apparatus according to claim 1, further including:
a first multi door mechanism mounted between the heating chamber and the hot plate proximate an entrance to the heating chamber; and
a second multi door mechanism mounted between the heating chamber and the hot plate proximate an exit way from the heating chamber.

5. The apparatus according to claim 4, wherein said first multi door mechanism is a first double door mechanism; and wherein said second multi door mechanism is a second double door mechanism.

6. The apparatus according to claim 4, wherein said first multi door mechanism is a first triple door mechanism; and wherein said second multi door mechanism is a second triple door mechanism.

7. The apparatus according to claim 1, wherein the heating chamber is U-shaped when viewed from above.

8. The apparatus according to claim 1, wherein the heating chamber is C-shaped when viewed from above.

9. The apparatus according to claim 1, wherein the hot plate is a conveyor.

10. The apparatus according to claim 1, further including a stop-and-start mechanism connected to the motor.

11. A method for heating a food product, comprising:
placing the food product on a hot plate;
heating the food product on the hot plate; and
heating the food product with a microwave mode of heating performed simultaneously with said step of heating the food product on the hot plate.

12. The method according to claim 11, further including moving the hot plate performed simultaneously with said step of heating the food product on the hot plate.

13. The method according to claim 11, further including heating the food product with hot circulated air performed simultaneously with said step of heating the food product on the hot plate.

14. The method according to claim 12, further including heating the food product with hot circulated air performed simultaneously with said step of heating the food product on the hot plate.

15. The method according to claim 12, wherein said step of moving the hot plate further comprises stopping and starting the movement of the hot plate.
